(19) United States
(12) Patent Application Publication
(10) Pub. No.: US 2014/0046629 A1
(43) Pub. Date: Feb. 13, 2014

(54) METHOD AND APPARATUS FOR MONITORING DEPOSITION

(71) Applicants: Kaikai Wu, Shanghai (CN); Linna Wang, Shanghai (CN)

(72) Inventors: Kaikai Wu, Shanghai (CN); Linna Wang, Shanghai (CN)

(21) Appl. No.: 13/254,922

(22) PCT Filed: May 4, 2011
(86) PCT No.: PCT/CN2011/000782

§ 371 Date: Sep. 6, 2011

(51) Int. Cl. G01N 27/02

(52) U.S. Cl. CPC G01N 27/021
USPC 702/170; 324/699

(57) ABSTRACT

The present invention concerns an apparatus for deposition monitoring in a water system comprising a deposition measurement system, a DC power supply connected to a conductive deposition monitoring surface and a counter electrode, the apparatus has a first treatment configuration and a second treatment configuration, wherein one of the treatment configurations removes biofilm from the conductive deposition monitoring surface, and the other treatment configuration removes inorganic scale deposition from the conductive deposition monitoring surface.

### BACKGROUND OF THE INVENTION

1. Field of the Invention

This invention is related to the selective detection and removal of inorganic scale and biofilm.

2. Description of Related Art

Deposition monitors are utilized to monitor the inorganic scale and biofilm deposition on water system components, such as heat exchangers. However, currently available deposition monitors are unable to differentiate between inorganic scale deposition and biofilm deposition. Further, currently available deposition monitors require a manual cleaning to remove deposition before they can be reused. This manual cleaning requires the deposition monitors to be removed from the water system.

Accordingly, a need exists for a deposition monitor for a water system that does not require a manual cleaning before re-use, and is capable of differentiating between inorganic scale deposition and biofilm deposition.

### SUMMARY OF THE INVENTION

In one aspect of the invention a method of deposition monitoring in a water system is comprised of: inserting a deposition measurement system, a conductive deposition monitoring surface and a counter electrode into the water system, the conductive deposition monitoring surface and the counter electrode are connected to a DC power supply; exposing the conductive deposition monitoring surface to the water, obtaining a baseline measurement of deposition DM₀, and recording the current time as T₀; collecting deposition on the conductive deposition monitoring surface for a predetermined length of time; obtaining a first measurement of deposition DM₁ on the conductive deposition monitoring surface and recording the current time as T₁; initiating a current through the conductive deposition monitoring surface and counter electrode with the DC power supply in a first treatment configuration, and terminating the current after a predetermined length of time; obtaining a second measurement of deposition DM₂ on the conductive deposition monitoring surface and recording the current time as T₂; initiating a current through the conductive deposition monitoring surface and counter electrode with the DC power supply in a second treatment configuration, and terminating the current after a predetermined length of time; and obtaining a third measurement of deposition DM₃ on the conductive deposition monitoring surface and recording the current time as T₃.

In another aspect of the method, the first treatment configuration is comprised of: connecting the conductive deposition monitoring surface to receive a negative polarity voltage from the DC power supply and connecting the counter electrode to receive a positive polarity voltage from the DC power supply; wherein the first treatment configuration removes biofilm deposition from the conductive deposition monitoring surface; and wherein the second treatment configuration is comprised of: connecting the conductive deposition monitoring surface to receive a positive polarity voltage from the DC power supply and connecting the counter electrode to receive a negative polarity voltage from the DC power supply; wherein the second treatment configuration removes inorganic scale deposition from the conductive deposition monitoring surface.

In another aspect, the method further comprises calculating a rate of biofilm deposition using: (DM₁−DM₂)/(T₁−T₀); calculating a rate of inorganic scale deposition using: (DM₂−DM₃)/(T₂−T₀); and calculating a rate of other depositions using: (DM₃−DM₀)/(T₃−T₀); wherein the thickness of biofilm removed by the first treatment configuration is equivalent to: DM₁−DM₂; wherein the thickness of inorganic scale removed by the second treatment configuration is equivalent to: DM₁−DM₃; and wherein the thickness of other deposition present on the conductive deposition monitoring surface is equivalent to: DM₃.

In another aspect of the method, the first treatment configuration is comprised of: connecting the conductive deposition monitoring surface to receive a positive polarity voltage from the DC power supply and connecting the counter electrode to receive a negative polarity voltage from the DC power supply; wherein the first treatment configuration removes inorganic scale deposition from the conductive deposition monitoring surface; and wherein the second treatment configuration is comprised of: connecting the conductive deposition monitoring surface to receive a negative polarity voltage from the DC power supply and connecting the counter electrode to receive a positive polarity voltage from the DC power supply; wherein the second treatment configuration removes biofilm deposition from the conductive deposition monitoring surface.

In another aspect, the method further comprises: calculating a rate of inorganic scale deposition using: (DM₁−DM₂)/(T₁−T₀); calculating a rate of biofilm deposition using: (DM₂−DM₃)/(T₂−T₀); calculating a rate of other depositions using: (DM₃−DM₀)/(T₃−T₀); wherein the thickness of inorganic scale removed by the first treatment configuration equivalent to: DM₁−DM₂; wherein the thickness of biofilm removed by the second treatment configuration is equivalent to: DM₂−DM₃; and wherein the thickness of other deposition present on the conductive deposition monitoring surface is equivalent to: DM₃.

In another aspect of the method, the deposition thicknesses are obtained through a deposition measurement system that uses one or more of the electrical, optical, or thermal properties of the conductive deposition monitoring surface to measure deposition on the conductive deposition monitoring surface.

In another aspect of the method, the current in the first treatment configuration is terminated after flowing between about 5 seconds to about 300 seconds, and the current in second treatment configuration is terminated after flowing between about 5 seconds to about 300 seconds.

In another aspect of the method, deposition is collected on the conductive deposition monitoring surface for a predetermined length of time between about one hour and about one year.

In another aspect of the method, deposition is collected on the conductive deposition monitoring surface for a predetermined length of time between about one month and about three months.

In another aspect of the method, deposition is collected on the conductive deposition monitoring surface for a predetermined length of time between about one week and about one month.

In yet another aspect of the invention, an apparatus for deposition monitoring in a water system comprises: a deposition measurement system; a DC power supply connected to a conductive deposition monitoring surface and a counter electrode; the apparatus having a first treatment configuration and a second treatment configuration; and wherein one of the treatment configurations removes biofilm from the conductive deposition monitoring surface, and the other of the treatment configurations removes inorganic scale deposition from the conductive deposition monitoring surface.

In another aspect of the apparatus, the conductive deposition monitoring surface is connected to receive positive polarity voltage from the DC power supply and the counter electrode is connected to receive negative polarity voltage from the DC power supply in the first treatment configuration; and the conductive deposition monitoring surface is connected to receive negative polarity voltage from the DC power supply and the counter electrode is connected to receive positive polarity voltage from the DC power supply in the second treatment configuration.

In another aspect of the apparatus, the apparatus calculates a rate of biofilm deposition, cumulative biofilm deposition, a rate of inorganic scale deposition, and cumulative inorganic scale deposition.

In another aspect of the apparatus, conductive deposition monitoring surface is connected to receive negative polarity voltage from the DC power supply and the counter electrode is connected to receive positive polarity voltage from the DC power supply in the first treatment configuration; and the conductive deposition monitoring surface is connected to receive positive polarity voltage from the DC power supply and the counter electrode is connected to receive negative polarity voltage from the DC power supply in the second treatment configuration.

In another aspect of the apparatus, the apparatus calculates a rate of biofilm deposition, cumulative biofilm deposition, a rate of inorganic scale deposition, and cumulative inorganic scale deposition.

In yet another aspect of the invention, a method of deposition monitoring in a water system comprises: inserting a deposition measurement system, a conductive deposition monitoring surface and a counter electrode into the water system, the conductive deposition monitoring surface and the counter electrode are connected to a DC power supply; exposing the conductive deposition monitoring surface to the water and recording the current time as T₀; obtaining a first measurement of deposition DM₁ on the conductive deposition monitoring surface and recording the current time as T₁; repeating the first measurement of deposition DM₁ on the conductive deposition monitoring surface and recording the current time as T₁ until the first measurement of deposition DM₁ exceeds a predetermined thickness; initiating a current through the conductive deposition monitoring surface and counter electrode with DC power supply in a first treatment configuration, monitoring the rate of deposition removal from the conductive deposition monitoring surface, and terminating the current when the rate of deposition removal from the conductive deposition monitoring surface is less than a predetermined rate of deposition removal; obtaining a second measurement of deposition DM₂ on the conductive deposition monitoring surface and recording the current time as T₂; initiating a current through the conductive deposition monitoring surface and counter electrode with DC power supply in a second treatment configuration, monitoring the rate of deposition removal from the conductive deposition monitoring surface, and terminating the current when the rate of deposition removal from the conductive deposition monitoring surface is less than a predetermined rate of deposition removal; and obtaining a third measurement of deposition DM₃ on the conductive deposition monitoring surface and recording the current time as T₃; and calculating at least one deposition statistic.

In another aspect of the method, biofilm deposition is removed from the conductive deposition monitoring surface in the first treatment configuration by: connecting the conductive deposition monitoring surface to receive negative polarity voltage from the DC power supply and connecting the counter electrode to receive positive polarity voltage from the DC power supply; inorganic scale deposition is removed from the conductive deposition monitoring surface in the second treatment configuration by: connecting the conductive deposition monitoring surface to receive positive polarity voltage from the DC power supply and connecting the counter electrode to receive negative polarity voltage from the DC power supply; and the predetermined rate of deposition removal is between about 2 μm/second to about 0.25 μm/second.

In another aspect of the method, inorganic scale deposition is removed from the conductive deposition monitoring surface in the first treatment configuration by: connecting the conductive deposition monitoring surface to receive positive polarity voltage from the DC power supply and connecting the counter electrode to receive negative polarity voltage from the DC power supply; biofilm deposition is removed from the conductive deposition monitoring surface in the second treatment configuration by: connecting the conductive deposition monitoring surface to receive negative polarity voltage from the DC power supply and connecting the counter electrode to receive positive polarity voltage from the DC power supply; and the predetermined rate of deposition removal is between about 2 μm/second to about 0.25 μm/second.

In another aspect of the method, the deposition statistics are comprised of the rate of biofilm deposition, rate of inorganic deposition, and rate of other depositions.

In yet another aspect of the invention, a method of deposition monitoring in a water system comprising: inserting a deposition measurement system, a conductive deposition monitoring surface and a counter electrode into the water system, the conductive deposition monitoring surface and the counter electrode are connected to a DC power supply; exposing the conductive deposition monitoring surface to the water, obtaining a baseline measurement of deposition DM₀ and recording the current time as T₀; collecting deposition on the conductive deposition monitoring; obtaining a first measurement of deposition DM₁ on the conductive deposition monitoring surface and recording the current time as T₁; initiating a current through the conductive deposition monitoring surface and counter electrode with DC power supply in a first treatment configuration, and terminating the current after a predetermined length of time; obtaining a second measurement of deposition DM₂ on the conductive deposition monitoring surface and recording the current time as T₂; initiating a current through the conductive deposition monitoring surface and counter electrode with DC power supply in a second treatment configuration, and terminating the current after a predetermined length of time; obtaining a third measurement of deposition DM₃ on the conductive deposition monitoring surface and recording the current time as T₃; and calculating at least one deposition statistic.

In another aspect of the method, deposition is collected on the conductive deposition monitoring surface until a predetermined length of time elapses, or an abnormal operation of the water system occurs that increases deposition risks.

In another aspect of the method, currents in the first and second treatment configurations are terminated after a predetermined length of time elapses or the rate of deposition removal from the conductive deposition monitoring surface is less than a predetermined rate of deposition removal.

Advantages of the present invention will become more apparent to those skilled in the art from the following description of the embodiments of the invention which have been shown and described by way of illustration. As will be realized, the invention is capable of other and different embodiments, and its details are capable of modification in various respects.

### BRIEF DESCRIPTION OF THE DRAWINGS

These and other aspects of the invention will be understood from the description and claims herein, taken together with the drawings showing details of construction and illustrative embodiments, wherein:

FIGS. 1a-b schematically illustrates one embodiment of an apparatus for monitoring deposition in accordance with the present invention;

FIG. 2 is a flow chart illustrating a method of operating the apparatus of FIG. 1;

FIG. 3 is a flow chart illustrating a method of operating the apparatus of FIG. 1;

FIG. 4 is a flow chart illustrating a method of operating the apparatus of FIG. 1;

FIG. 5 is a graph illustrating the operation of the apparatus in accordance with the method of FIG. 2;

FIG. 6 is a graph illustrating the operation of the apparatus in accordance with the method of FIG. 3; and

FIG. 7 is a graph illustrating the operation of the apparatus in accordance with the method of FIG. 4.

It should be noted that all the drawings are diagrammatic and not drawn to scale. Relative dimensions and proportions of parts of these figures have been shown exaggerated or reduced in size for the sake of clarity and convenience in the drawings. The same reference numbers are generally used to refer to corresponding or similar features in the different embodiments. Accordingly, the drawing(s) and description are to be regarded as illustrative in nature and not as restrictive.

### DETAILED DESCRIPTION OF THE INVENTION

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges stated herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises”, “comprising”, “includes”, “including”, “has”, “having”, or any other variation thereof, are intended to cover a non-exclusive inclusion. For example, a process, method, article or apparatus that comprises a list of elements is not necessarily limited to only those elements, but may include other elements not expressly listed or inherent to such process, method, article, or apparatus.

The singular forms “a”, “an”, and “the” include plural referents unless the context clearly dictates otherwise.

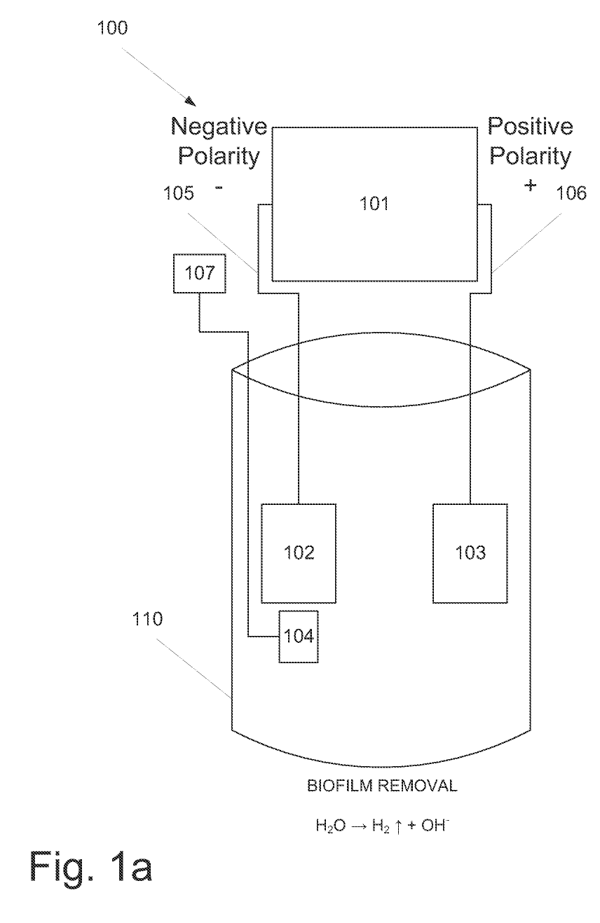

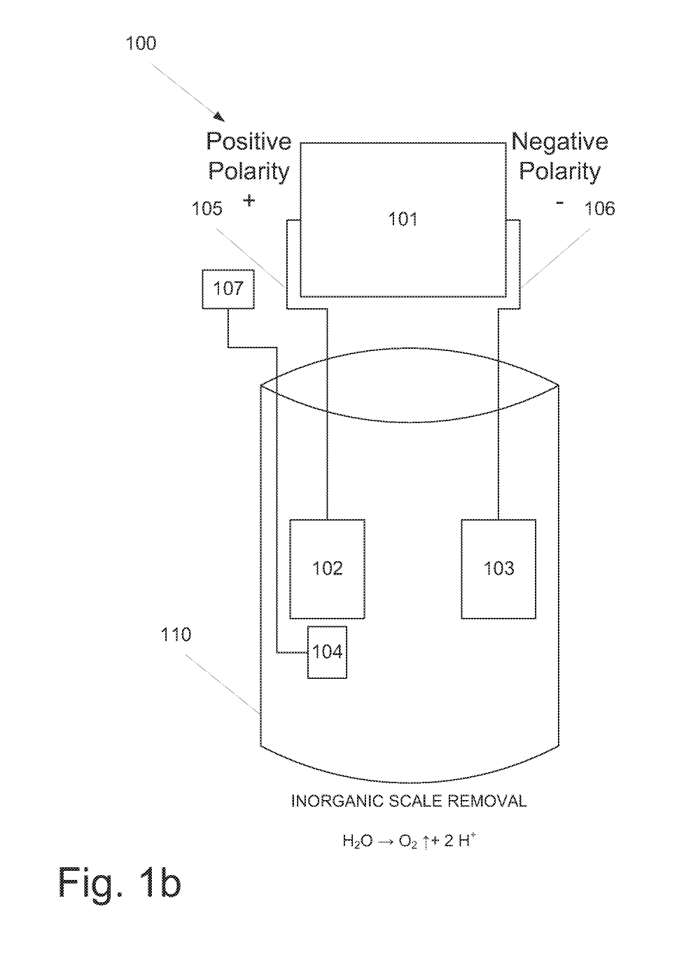

Disclosed in FIG. 1 is a deposition monitoring apparatus 100 comprised of a DC power supply 101, a conductive deposition monitoring surface 102, a counter electrode 103, and a deposition measurement system 104. A first lead 105 connects the DC power supply 101 to the conductive deposition monitoring surface 102. A second lead 106 connects the DC power supply 101 to the counter electrode. Deposition measurement system 104 has a readout 107. It is understood that in some embodiments, DC power supply 101 and deposition measurement system readout 107 can be contained in the same enclosure. Deposition measurement system 104 uses one or more of the electrical, optical, or thermal properties of said conductive deposition monitoring surface 102 to measure deposition on said conductive deposition monitoring surface. In one embodiment, deposition measurement system 104 is integrated into conductive deposition monitoring surface 102.

Deposition monitoring surface 102 and counter electrode 103 are comprised of a conductive material including, but are not limited to, stainless steel, carbon steel, admiralty, brass, copper, cast iron, nickel, aluminum, titanium, and their alloys. It is also contemplated that persons having ordinary skill in the art can choose to use another material to match the metallurgy of their particular water system 110. In some embodiments the conductive material is non-corroding. Further, in some embodiments, deposition monitoring surface 102 and counter electrode 103 are comprised of the same materials, and in other embodiments monitoring surface 102 and counter electrode 103 are comprised of different materials.

In one embodiment, deposition monitoring surface 102 is a stainless steel coupon having a surface area of about 7-8 cm² and the counter electrode 103 is a platinum needle. The deposition monitoring surface 102 and counter electrode 103 are about 1-2 cm apart, parallel, and face one another. The conductivity of the water in the embodiment is about 1,000 μS/cm. However, it is contemplated that a person having ordinary skill in the art can choose to use a variety of materials for the deposition monitoring surface 102 and counter electrode 103. Further, it is contemplated that a person having ordinary skill in the art can use deposition monitoring surfaces 102 and counter electrodes 103 of various sizes and orient them in a variety of configurations. Lastly, it is contemplated that the conductivity of the water will change from one water system 110 to another. Further, it is understood that in both the first and second treatment configurations, a current is initiated through the conductive deposition monitoring surface 102 and the counter electrode 103 with the DC power supply 101. The first and second treatment configurations are exited by terminating the current.

In practice, conductive deposition monitoring surface 102, counter electrode 103, and deposition measurement system 104 are placed inside water system 110. Deposition measurement system 104 can be one of several commercially available deposition measurement systems which detect deposition using electrical property based detection technology, optical property based detection technology, and/or thermal property based detection technology. Deposition measurement systems that use thermal property based detection technology measure the increase of thermal resistance as an index for deposition growth. Such deposition measurement systems are discussed in US Patent Application 20020060020, U.S. Pat. No. 6,107,603, and U.S. Pat. No. 5,576,481, all of which are herein incorporated by reference.

Deposition monitoring apparatus 100 uses electrolysis to selectively identify and remove biofilm and inorganic scale depositions from conductive deposition monitoring surface 102.

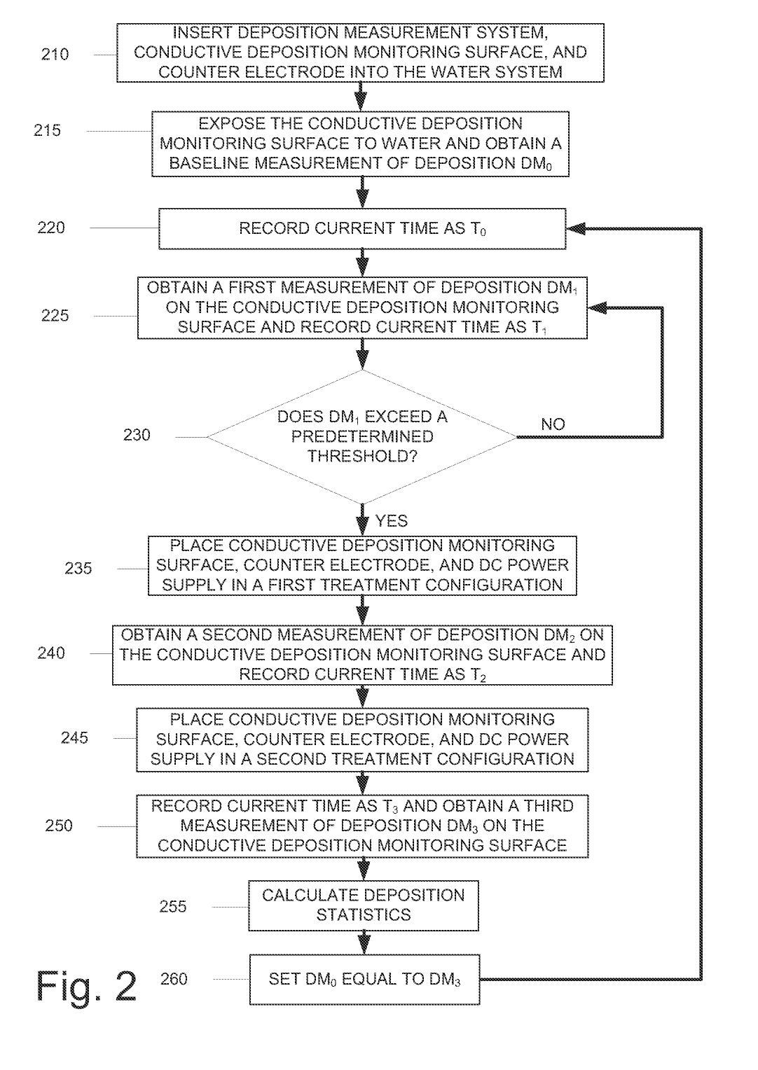

In one embodiment, deposition monitoring apparatus 100 removes depositions of either biofilm or inorganic scale deposition in a first treatment configuration from conductive deposition monitoring surface 102 on an as needed basis, and removes depositions of the other of biofilm or inorganic scale deposition in a second treatment configuration from conductive deposition monitoring surface 102 on an as needed basis, such as when the thickness of deposition on the conductive deposition monitoring surface 102 exceeds a predetermined threshold. Accordingly, if the first treatment configuration removes biofilm, then the second treatment configuration removes inorganic scale deposition. Further, it is contemplated that if the first treatment removes inorganic scale deposition, then the second treatment configuration removes biofilm deposition. Deposition apparatus 100 exits the first and second treatment configurations when the rate of removal of deposition from the conductive deposition monitoring surface 102 is less than a predetermined value. Deposition apparatus 100 also calculates deposition statistics, such as the thickness of the biofilm deposition, inorganic scale deposition, and other deposition on conductive deposition monitoring surface 102 and the biofilm deposition, inorganic scale deposition, and other deposition rates. This embodiment is shown in FIG. 2.

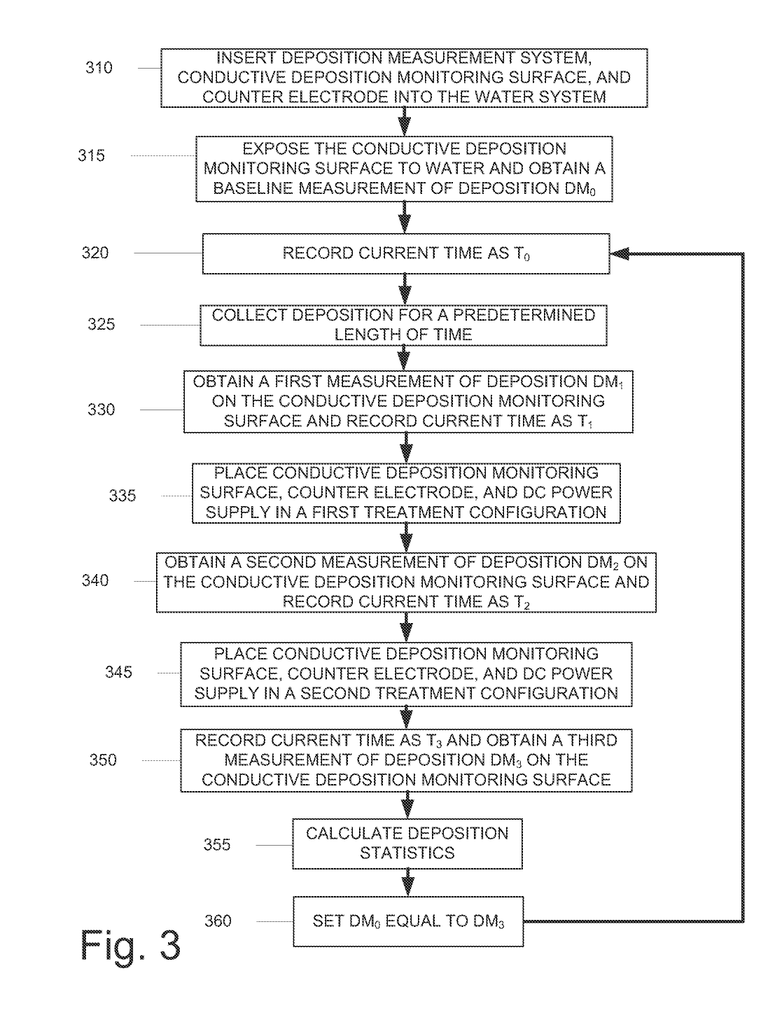

In one embodiment, deposition monitoring apparatus 100 permits deposition to collect on the conductive deposition monitoring surface 102 for a predetermined length of time and removes depositions of either biofilm or inorganic scale deposition in a first treatment configuration from conductive deposition monitoring surface 102 and removes depositions of the other of biofilm or inorganic scale deposition in a second treatment configuration from conductive deposition monitoring surface 102. Accordingly, if the first treatment configuration removes biofilm, then the second treatment configuration removes inorganic scale deposition. Further, it is contemplated that if the first treatment removes inorganic scale deposition, then the second treatment configuration removes biofilm deposition. In this embodiment, deposition monitoring apparatus remain in the first and second treatment configurations for a predetermined length of time. Deposition apparatus 100 also calculates deposition statistics, such as the thickness of the biofilm deposition, inorganic scale deposition, and other deposition on conductive deposition monitoring surface 102 and the biofilm deposition, inorganic scale deposition, and other deposition rates. This embodiment is shown in FIG. 3.

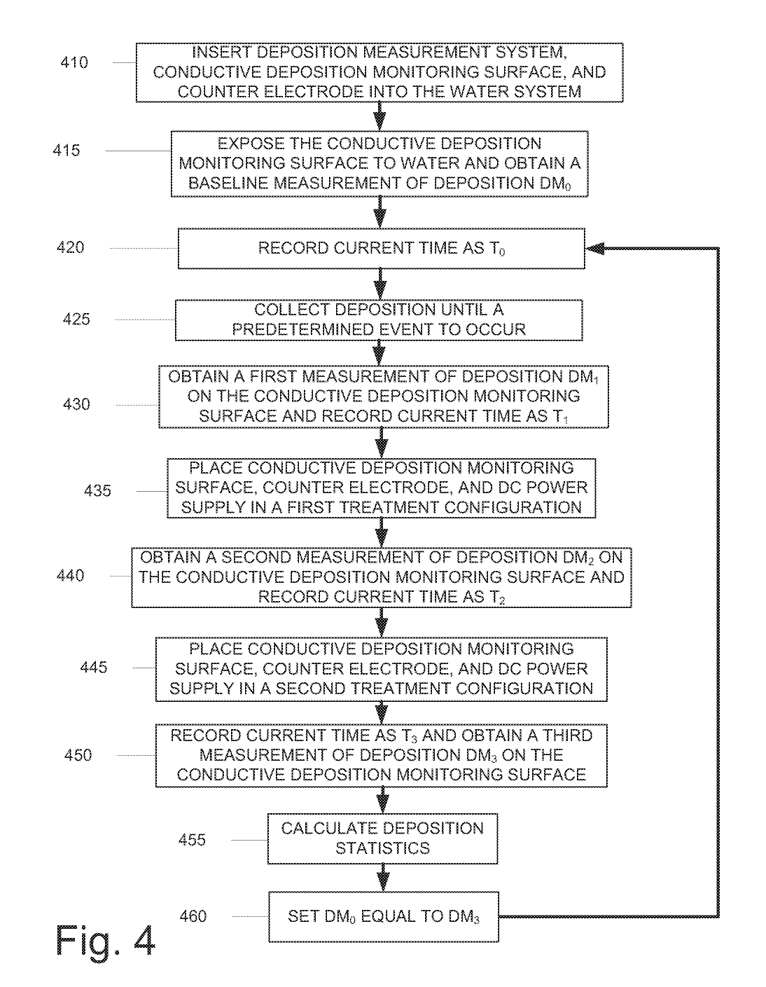

In one embodiment, deposition monitoring apparatus 100 permits deposition to collect on the conductive deposition monitoring surface 102 until a predetermined event to occurs, and then begins to remove depositions of either biofilm or inorganic scale deposition in a first treatment configuration from conductive deposition monitoring surface 102 and removes depositions of the other of biofilm or inorganic scale deposition in a second treatment configuration from conductive deposition monitoring surface 102 at a predetermined time interval. Such predetermined events could include, but are not limited to the elapsing of a predetermined amount of time, or the accumulation of a predetermined thickness of deposition on the deposition monitoring surface 102, or any abnormal operation of the water system that increases deposition risks. In this embodiment, if the first treatment configuration removes biofilm, then the second treatment configuration removes inorganic scale deposition. Further, it is contemplated that if the first treatment removes inorganic scale deposition, then the second treatment configuration removes biofilm deposition. In this embodiment, deposition monitoring apparatus could remain in the first and second treatment configurations for a predetermined length of time. Alternatively, in this embodiment Deposition apparatus 100 also calculates deposition statistics, such as the thickness of the biofilm deposition, inorganic scale deposition, and other deposition on conductive deposition monitoring surface 102 and the biofilm deposition, inorganic scale deposition, and other deposition rates. This embodiment is shown in FIG. 4.

As can be seen in the discussion of the figures above, it is contemplated that in some embodiments, the first treatment configuration of deposition monitoring apparatus 100 removes biofilm deposition from the conductive deposition monitoring surface 102. This is accomplished by connecting the conductive deposition monitoring surface 102 to receive a negative polarity voltage from the DC power supply 101 and connecting the counter electrode 103 to receive a positive polarity voltage from the DC power supply 101, and applying voltage to and initiating a current through the conductive deposition monitoring surface 102 and the counter electrode 103 with the DC power supply 101. Further, the second treatment configuration of deposition monitoring apparatus 100 removes inorganic scale from the conductive deposition monitoring surface 102. This is accomplished by connecting the conductive deposition monitoring surface 102 to receive a positive polarity voltage from the DC power supply 101 and connecting the counter electrode 103 to receive a negative polarity voltage from the DC power supply 101, and applying voltage to and initiating a current through the conductive deposition monitoring surface 102 and the counter electrode 103 with the DC power supply 101.

Additionally, it is contemplated in other embodiments, the first treatment configuration of deposition monitoring apparatus 100 removes inorganic scale from the conductive deposition monitoring surface 102. This is accomplished by connecting the conductive deposition monitoring surface 102 to receive a positive polarity voltage from the DC power supply 101 and connecting the counter electrode 103 to receive a negative polarity voltage from the DC power supply 101, and applying voltage to and initiating a current through the conductive deposition monitoring surface 102 and the counter electrode 103 with the DC power supply 101. Further, the second treatment configuration of deposition monitoring apparatus 100 removes biofilm deposition from the conductive deposition monitoring surface 102. This is accomplished by connecting the conductive deposition monitoring surface 102 to receive a negative polarity voltage from the DC power supply 101 and connecting the counter electrode 103 to receive a positive polarity voltage from the DC power supply 101, and applying voltage to and initiating a current through the conductive deposition monitoring surface 102 and the counter electrode 103 with the DC power supply 101.

Turning to FIG. 2, the flowchart discloses a method of using deposition monitoring apparatus 100. In step 210, deposition measurement system 104, conductive deposition monitoring surface 102, and counter electrode 103 are inserted into water system 110. In step 215, conductive deposition monitoring surface 102 is exposed to the water in water system 110 and a baseline measurement of deposition DM₀ on the conductive deposition monitoring surface 102 is obtained. In step 220, the current time is recorded as T₀. In step 225, a first measurement of deposition DM₁ on the conductive deposition monitoring surface is obtained from deposition measurement system 104 and the current time is recorded as T₁. In step 230, if DM₁ exceeds a predetermined threshold, the method proceeds to step 235, if DM₁ does not exceed a predetermined threshold the method proceeds to step 225.

In step 235, in one embodiment, deposition monitoring apparatus 100 is placed in a first treatment configuration until the rate of deposition removal from the conductive deposition monitoring surface 102 is less than a predetermined rate.

In step 235, in another embodiment, deposition monitoring apparatus 100 is placed in a first treatment configuration for a predetermined amount of time. In one embodiment, the predetermined amount of time can be between about 5 seconds and about 300 seconds, preferably between about 30 seconds and 180 seconds, most preferably about 60˜120 seconds. In step 240, a second measurement of deposition DM₂ on the conductive deposition monitoring surface is obtained from deposition measurement system 104 and the current time is recorded as T₂.

In step 245, in one embodiment, the deposition monitoring system 100 is placed in a second treatment configuration until the rate of deposition removal from conductive deposition monitoring surface 102 is less than a predetermined rate.

In step 245, in another embodiment, deposition monitoring apparatus 100 is placed in a second treatment configuration for a predetermined amount of time. In one embodiment, the predetermined amount of time can be between about 5 seconds and about 120 seconds, preferably between about 30 seconds and 90 seconds, most preferably about 60 seconds.

In step 250, a third measurement of deposition DM₃ on the conductive deposition monitoring surface 102 is obtained and the current time is recorded at T₃.

In step 255, the deposition statistics are calculated, such as the rates and thicknesses of the biofilm, inorganic scaling, and other depositions. If biofilm deposition is removed in step 235 and inorganic scale deposition is removed in step 245, the rate of biofilm deposition is (DM₁−DM₂)/(T₁−T₀), the rate of inorganic scale deposition is (DM₂−DM₃)/(T₂−T₀), the rate of other deposition is (DM₃-DM₀)/(T₃−T₀), the thickness of biofilm deposition removed in step 235 is DM₁−DM₂, the thickness of other deposition present on conductive deposition monitoring surface 102 is DM₃, and the thickness of inorganic scale deposition removed in step 245 is DM₂−DM₃.

If inorganic scale deposition is removed in step 235 and biofilm deposition is removed in step 245, the rate of inorganic scale deposition is (DM₁−DM₂)/(T₁−T₀), the rate of biofilm deposition is (DM₂−DM₃)/(T₂−T₀), the rate of other deposition is (DM₃−DM₀)/(T₃−T₀), the thickness of inorganic scale deposition removed in step 235 is DM₁−DM₂, the thickness of other deposition present on conductive deposition monitoring surface 102 is DM₃, and the thickness of biofilm deposition removed in step 245 is DM₂−DM₃. Other deposition can be any deposition, apart from biofilm and inorganic scale, which collects on conductive deposition monitoring surface 102.

In step 260, DM₀ is set equal to DM₃. After step 260, the method progresses to step 220.

In addition to calculating the deposition rates and thicknesses in step 255, it is contemplated that some embodiments may also keep track of the cumulative amount of biofilm deposition removed and the cumulative amount of inorganic scale deposition removed in steps 235 and 245, and the combined cumulative amount of both inorganic scale and biofilm deposition removed in steps 235 and 245.

Turning to FIG. 3, the flowchart discloses another method of using deposition monitoring apparatus 100. In step 310, deposition measurement system 104, conductive deposition monitoring surface 102, and counter electrode 103 are inserted into water system 110. In step 315, conductive deposition monitoring surface 102 is exposed to the water and a baseline measurement of deposition DM₀ on the conductive deposition monitoring surface 102 is obtained. In step 320, the current time is recorded at T₀.

In step 325, deposition is collected on the conductive deposition monitoring surface 102 for a predetermined length of time before progressing to step 330. In one embodiment, the predetermined length of time is between about 1 hour and 24 hours. In another embodiment, the predetermined length of time is between about 1 day and 1 week. In an additional embodiment, the predetermined length of time is between about 1 week and 1 month. In a further embodiment, the predetermined length of time is between about 1 month and 3 months. In another embodiment, the predetermined length of time is between about 1 month and 1 year.

In step 330, a first measurement DM₁ of deposition on said conductive deposition monitoring surface is obtained and the current time is recorded at T₁. In step 335, deposition monitoring apparatus 100 is placed in a first treatment configuration.

In step 335, in one embodiment, deposition monitoring apparatus 100 is placed in a first treatment configuration until the rate of deposition removal from the conductive deposition monitoring surface 102 is less than a predetermined rate.

In step 335, in another embodiment, deposition monitoring apparatus 100 is placed in a first treatment configuration for a predetermined amount of time. In one embodiment, the predetermined amount of time can be between about 5 seconds and about 120 seconds, preferably between about 30 seconds and 90 seconds, most preferably about 60 seconds.

In step 340, a second measurement of deposition DM₂ on the conductive deposition monitoring surface is obtained from deposition measurement system 104 and the current time is recorded as T₂.

In step 345, in one embodiment, the deposition monitoring system 100 is placed in a second treatment configuration until the rate of deposition removal from conductive deposition monitoring surface 102 is less than a predetermined rate.

In step 345, in another embodiment, deposition monitoring apparatus 100 is placed in a second treatment configuration for a predetermined amount of time. In one embodiment, the predetermined amount of time can be between about 5 seconds and about 120 seconds, preferably between about 30 seconds and 90 seconds, most preferably about 60 seconds.

In step 350, a third measurement of deposition DM₃ on the conductive deposition monitoring surface 102 is obtained and the current time is recorded at T₃.

In step 355, the deposition statistics are calculated, such as the rates and thicknesses of the biofilm, inorganic scaling, and other depositions. If biofilm deposition is removed in step 335 and inorganic scale deposition is removed in step 345, the rate of biofilm deposition is (DM₁−DM₂)/(T₁−T₀), the rate of inorganic scale deposition is (DM₂−DM₃)/(T₂−T₀), the rate of other deposition is (DM₃−DM₀)/(T₃−T₀), the thickness of biofilm deposition removed in step 335 is DM₁−DM₂, the thickness of other deposition present on conductive deposition monitoring surface 102 is DM₃, and the thickness of inorganic scale deposition removed in step 345 is DM₂−DM₃.

If inorganic scale deposition is removed in step 335 and biofilm deposition is removed in step 345, the rate of inorganic scale deposition is (DM₁−DM₂)/(T₁−T₀), the rate of biofilm deposition is (DM₂−DM₃)/(T₂−T₀), the rate of other deposition is (DM₃−DM₀)/(T₃−T₀), the thickness of inorganic scale deposition removed in step 335 is DM₁−DM₂, the thickness of other deposition present on conductive deposition monitoring surface 102 is DM₃, and the thickness of biofilm deposition removed in step 345 is DM₂−DM₃. Other deposition can be any deposition, apart from biofilm and inorganic scale, that collects on conductive deposition monitoring surface 102.

In step 360, DM₀ is set equal to DM₃. After step 360, the method progresses to step 320.

In addition to calculating the deposition rates and thicknesses in step 355, it is contemplated that some embodiments may also keep track of the cumulative amount of biofilm deposition removed and the cumulative amount of inorganic scale deposition removed in steps 335 and 345, and the combined cumulative amount of both inorganic scale and biofilm deposition removed in steps 335 and 345.

Turning to FIG. 4, the flowchart discloses a method of using deposition monitoring apparatus 100. In step 410, deposition measurement system 104, conductive deposition monitoring surface 102, and counter electrode 103 are inserted into water system 110. In step 415, conductive deposition monitoring surface 102 is exposed to the water in water system 110 and a baseline measurement of deposition DM₀ on the conductive deposition monitoring surface 102 is obtained.

In step 420, the current time is recorded as T₀. In step 425, deposition is collected on the conductive deposition monitoring surface 102 and proceeds to step 430 once a predetermined event occurs. Such predetermined events include, but are not limited to the accumulation of a predetermined amount of deposition on conductive deposition monitoring surface 102 or the elapsing of a predetermined length of time, or during or after any abnormal operation of the water system to that increases deposition risks. Abnormal operation of the water system includes, but is not limited to, changes in incoming make-up water, changes of heat load in water due to production variation or environmental changes, changes in water flow hydrodynamic, changes to water treatment programs, water system shutdown or startup, or process leakage into the water system. However, it is contemplated that a person having ordinary skill in the art can select another event as the predetermined event.

In step 430, a first measurement DM₁ of deposition on said conductive deposition monitoring surface is obtained and the current time is recorded at T₁. In step 435, deposition monitoring apparatus 100 is placed in a first treatment configuration.

In step 435, in one embodiment, deposition monitoring apparatus 100 is placed in a first treatment configuration until the rate of deposition removal from the conductive deposition monitoring surface 102 is less than a predetermined rate.

In step 435, in another embodiment, deposition monitoring apparatus 100 is placed in a first treatment configuration for a predetermined amount of time. In one embodiment, the predetermined amount of time can be between about 5 seconds and about 120 seconds, preferably between about 30 seconds and 90 seconds, most preferably about 60 seconds.

In step 440, a second measurement of deposition DM₂ on the conductive deposition monitoring surface is obtained from deposition measurement system 104 and the current time is recorded as T₂.

In step 445, in one embodiment, the deposition monitoring system 100 is placed in a second treatment configuration until the rate of deposition removal from conductive deposition monitoring surface 102 is less than a predetermined rate

In step 445, in another embodiment, deposition monitoring apparatus 100 is placed in a second treatment configuration for a predetermined amount of time. In one embodiment, the predetermined amount of time can be between about 5 seconds and about 120 seconds, preferably between about 30 seconds and 90 seconds, most preferably about 60 seconds.

In step 450, a third measurement of deposition DM₃ on the conductive deposition monitoring surface 102 is obtained and the current time is recorded at T₃.

In step 455, the deposition statistics are calculated, such as the rates and thicknesses of the biofilm, inorganic scaling, and other depositions. If biofilm deposition is removed in step 435 and inorganic scale deposition is removed in step 445, the rate of biofilm deposition is (DM₁−DM₂)/(T₁−T₀), the rate of inorganic scale deposition is (DM₂−DM₃)/(T₂−T₀), the rate of other deposition is (DM₃−DM₀)/(T₃−T₀), the thickness of biofilm deposition removed in step 435 is DM₁−DM₂, the thickness of other deposition present on conductive deposition monitoring surface 102 is DM₃, and the thickness of inorganic scale deposition removed in step 445 is DM₂−DM₃.

If inorganic scale deposition is removed in step 435 and biofilm deposition is removed in step 445, the rate of inorganic scale deposition is (DM₁−DM₂)/(T₁−T₀), the rate of biofilm deposition is (DM₂−DM₃)/(T₂−T₀), the rate of other deposition is (DM₃−DM₀)/(T₃−T₀), the thickness of inorganic scale deposition removed in step 435 is DM₁−DM₂, the thickness of other deposition present on conductive deposition monitoring surface 102 is DM₃, and the thickness of biofilm deposition removed in step 445 is DM₂−DM₃. Other deposition can be any deposition, apart from biofilm and inorganic scale, that collects on conductive deposition monitoring surface 102.

In step 460, DM₀ is set equal to DM₃. After step 460, the method progresses to step 420.

In FIGS. 2-4 deposition measurement system 104 is used to obtain DM₀, DM₁, DM₂, and DM₃. In some embodiments of the method depicted in FIGS. 2-4, deposition measurement system 104 is used to determine whether the rate of deposition removal from conductive deposition monitoring surface 102 is less than a predetermined rate. In one embodiment, the predetermined deposition thickness threshold in steps 230 is between about 10 μm to about 1,000 μm; the DC voltage supplied by DC power supply 101 is at least about 1V, preferably at least about 1.23V, and most preferably about 6V; the current density supplied by DC power supply 101 is between about 1 and 10,000 A/m², preferably between about 10 and 1,000 A/m², and most preferably between about 20 and 800 A/m². However, it is contemplated a person having ordinary skill in the art can select a different predetermined deposition thickness threshold, a different DC power supply voltage, and a different current density.

In some embodiments of steps 235, 245, 335, and 345, deposition measurement system 104 is used to monitor the rate of deposition removal by taking measurements of deposition on conductive deposition monitoring surface 102 at regular intervals and calculating the rate of deposition removal from conductive deposition monitoring surface 102 after each interval. In one embodiment the measurement interval can be between 1 second and 60 seconds, preferably between 10 seconds and 50 seconds, most preferably 20 seconds. In one embodiment with a measurement interval of, the predetermined rate of removal is between about 2 μm/second to about 0.25 μm/second, more preferably about 1.5 μm/second to about 0.5 um/second, most preferably about 1 μm/second. It is contemplated that these rates of removal can be scaled for the measurement interval; such as for a 20 second measurement interval, the predetermined rate of removal for one embodiment is between 40 μm/20 sec to about 10 μm/20 sec, most preferably about 20 μm/20 sec. However, it is contemplated a person having ordinary skill in the art can select a different measurement interval, predetermined deposition thickness threshold, a different DC power supply voltage, and/or a different rate of deposition removal.

Further, it is contemplated that the methods of FIGS. 2-4 can be carried out by a human, or automated, such as with a programmable logic controller or a computer. In embodiments in which the methods are automated, the calculated deposition statistics in steps 255, 355, and 455 can be reported directly to the user or transmitted to another device.

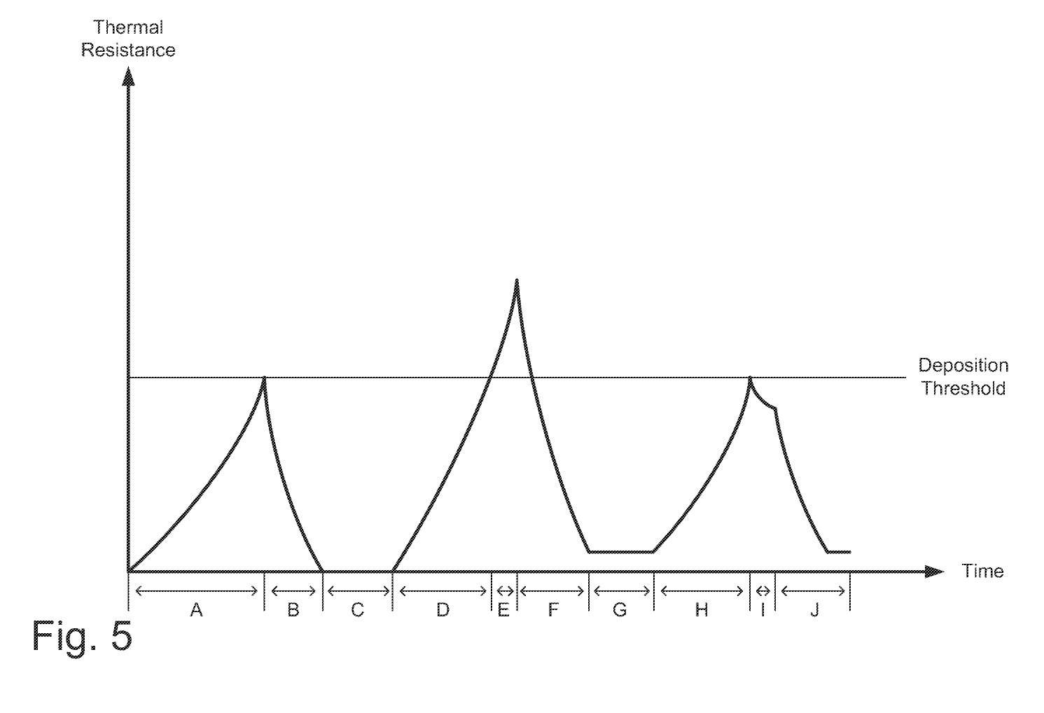

Turning to FIG. 5, an example of deposition monitoring apparatus 100 operating in accordance with the method of FIG. 2 is depicted. For purposes of this example, the first treatment configuration of deposition monitoring apparatus 100 removes biofilm deposition and the second treatment configuration of deposition monitoring apparatus 100 removes inorganic scaling deposition from conductive deposition monitoring surface 102. Further, deposition monitoring apparatus 100 remains in the first and second treatment configurations until the rate of deposition removal from conductive deposition monitoring surface 102 is less than a predetermined rate.

At the beginning of time period A, the current time is recorded as T₀, the conductive deposition monitoring surface 102 is exposed to the water, a baseline measurement of deposition DM₀ on conductive deposition monitoring surface 102 is obtained, and deposition begins to form on conductive deposition monitoring surface 102. Further, during time period A, a first measurement of deposition DM₁ is taken using deposition measurement system 104 and the current time is recorded as T₁. The step of taking a first measurement of deposition DM₁ and recording the current time as T₁ is repeated until DM₁ exceeds the predetermined deposition thickness threshold, which occurs at the end at time period A.

At the beginning of time period B, deposition monitoring apparatus is placed in a first treatment configuration and remains in the configuration until the rate of deposition removal from conductive deposition monitoring surface 102 is less than a predetermined rate of deposition removal. In this example, the first treatment configuration completely removes the deposition, so the deposition is identified as biofilm. After exiting the first treatment configuration, a second measurement of deposition DM₂ is obtained and the time is recorded as T₂. At this point, deposition monitoring apparatus 100 is placed in a second treatment configuration and quickly exits since the rate of deposition removal is below a predetermined rate of deposition removal due to the fact that all of the deposition was removed by the first treatment configuration. After exiting the second treatment configuration, a third measurement of deposition DM₃ is obtained and the time is recorded as T₃. The deposition statistics are calculated, such as the biofilm, inorganic scale, and other deposition rates and thicknesses, and DM₀ is set equal to DM₃.

At the beginning of time period C, the current time is recorded as T₀. During time periods C and D, a first measurement of deposition DM₁ is taken using deposition measurement system 104 and the current time is recorded as T₁. The step of taking a first measurement of deposition DM₁ and recording the current time as T₁ is repeated until DM₁ exceeds the predetermined deposition thickness threshold, which occurs at the end at time period D.

At the beginning of time period E, deposition monitoring apparatus 100 is placed in a first treatment configuration. At the end of time period E, deposition monitoring apparatus exits the first treatment configuration since the rate of deposition removal from conductive deposition monitoring surface 102 is less than a predetermined rate of deposition removal. After exiting the first treatment configuration, a second measurement of deposition DM₂ is obtained and the time is recorded as T₂. As one can see, the first treatment configuration did not remove any deposition from conductive deposition monitoring surface 102. Accordingly, the deposition is not biofilm.

At the beginning of time period F, deposition monitoring apparatus 100 is placed in a second treatment configuration and exits the second treatment configuration once the rate of deposition is less than a predetermined rate. After exiting the second treatment configuration at the end of time period F, a third measurement of deposition DM₃ is obtained and the time is recorded as T₃. The biofilm, inorganic scale, and other deposition statistics are calculated and DM₀ is set equal to DM₃.

As can be seen, the second treatment configuration successfully removed inorganic scale deposition during time period F. However, the first and second treatment configurations failed to completely remove all of the deposition from conductive deposition monitoring surface 102 during time periods E-F. This remaining deposition is classified as “other” deposition because it is not biofilm or inorganic scale deposition. Accordingly, the DM₃ value represents the thickness of the other deposition and is used to account for this other deposition when calculating the biofilm, inorganic scale, and other deposition rates and thicknesses. Additionally, In some embodiments, the total amounts of inorganic scale deposition and biofilm deposition removed during time periods B and F from conductive deposition monitoring surface 102 are also calculated.

At the beginning of time period G, the current time is recorded at T₀. During time periods G and H, a first measurement of deposition DM₁ on the conductive deposition monitoring surface is obtained using deposition measurement system 104 and the current time is recorded as T₁. The step of taking a first measurement of deposition DM₁ and recording the current time as T₁ is repeated until DM₁ exceeds the predetermined deposition thickness threshold at the end at time period H. At the beginning of time period I, deposition monitoring apparatus 100 is placed in a first treatment configuration and successfully removes the deposited biofilm deposition. At the end of time period I, deposition monitoring apparatus exits the first treatment configuration since the rate of deposition removal from conductive deposition monitoring surface 102 is less than a predetermined rate of deposition removal. After exiting the first treatment configuration, a second measurement of deposition DM₂ is obtained and the time is recorded as T₂.

At the beginning of time period J, deposition monitoring apparatus 100 is placed in a second treatment configuration and exits the second treatment configuration once the rate of deposition is less than a predetermined threshold. As can be seen, the second treatment configuration successfully removes inorganic scale deposition during time period H.

After exiting the second treatment configuration at the end of time period J, a third measurement of deposition DM₃ is obtained and the time is recorded as T₃. This third measurement of deposition DM₃ accounts for the other deposition remaining on conductive deposition monitoring surface 102 at the end of time period J. The biofilm, inorganic scale, and other deposition statistics are calculated and DM₀ is set equal to DM₃ to account for the other deposition remaining on conductive deposition monitoring surface 102. Additionally, in some embodiments, the total amounts of inorganic scale deposition and biofilm deposition removed during time periods B, F, I and J from conductive deposition monitoring surface 102 are also calculated.

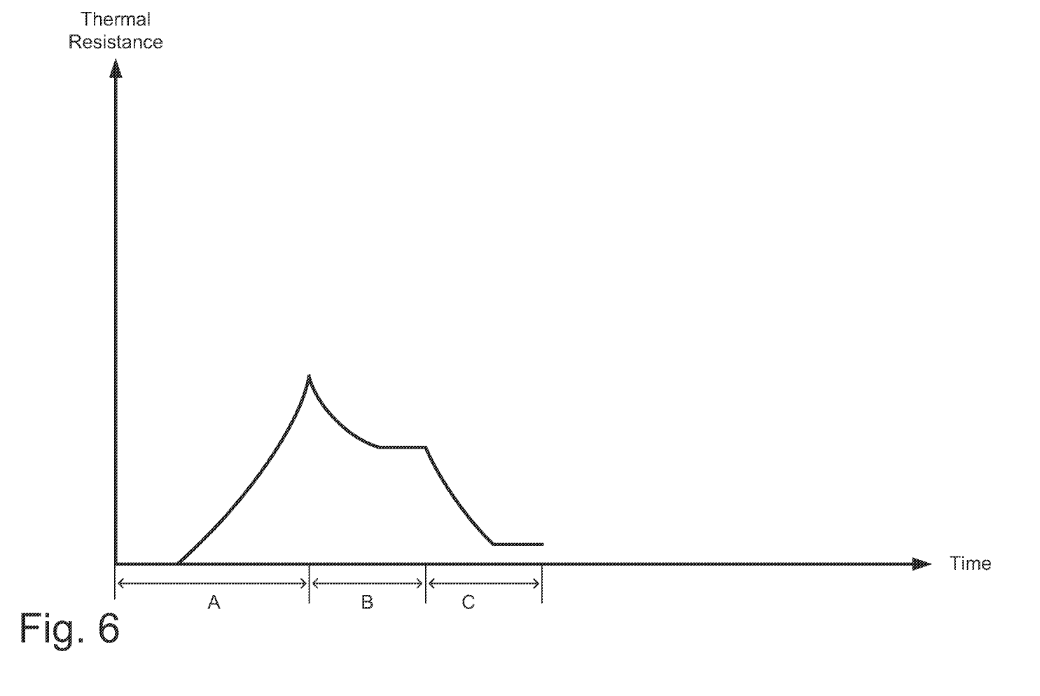

Turning to FIG. 6, an example of deposition monitoring apparatus 100 operating in accordance with the method of FIG. 3 is depicted. In this example, the first treatment configuration of deposition monitoring apparatus 100 removes biofilm deposition and the second treatment configuration of deposition monitoring apparatus 100 removed inorganic scaling deposition. Further, once deposition monitoring apparatus 100 enters the first or second treatment configurations, deposition monitoring apparatus 100 remains in the treatment configuration until a predetermined length of time has elapsed.

At the beginning of time period A, the conductive deposition monitoring surface 102 is exposed to the water, a baseline measurement of deposition DM₀ is obtained, and the current time is recorded as T₀, and deposition is collected on conductive deposition monitoring surface 102. Deposition continues forming on conductive deposition monitoring surface 102 throughout time period A, which ends once a predetermined amount of time elapses. At the beginning of time period B a first measurement of deposition DM₁ is taken using deposition measurement system 104, the current time is recorded as T₁, and deposition monitoring apparatus 100 is placed in a first treatment configuration. Deposition monitoring apparatus 100 remains in the first treatment configuration for a predetermined length of time, which elapses at the end of time period B. As can be seen, during time period B the first treatment configuration removed the biofilm portion of the deposition present on the conductive deposition monitoring surface 102. After exiting the first treatment configuration, a second measurement of deposition DM₂ is obtained and the time is recorded as T₂.

At the beginning of time period C, deposition monitoring apparatus 100 is placed in a second treatment configuration. Deposition monitoring apparatus 100 remains in the second treatment configuration for a predetermined length of time elapses, which elapses at the end of time period C. As can be seen, during time period C, the second treatment configuration removes the inorganic scale portion of the deposition present on the conductive deposition monitoring surface 102. However, a small portion of other deposition still remains on conductive deposition monitoring surface 102 at the end of time period C. After exiting the second treatment configuration, a third measurement of deposition DM₃ is obtained and the time is recorded as T₃. This third measurement of deposition DM₃ accounts for the other deposition remaining on conductive deposition monitoring surface 102 at the end of time period C. The deposition statistics are then calculated and DM₀ is set equal to DM₃ to account for the other deposition remaining on conductive deposition monitoring surface 102.

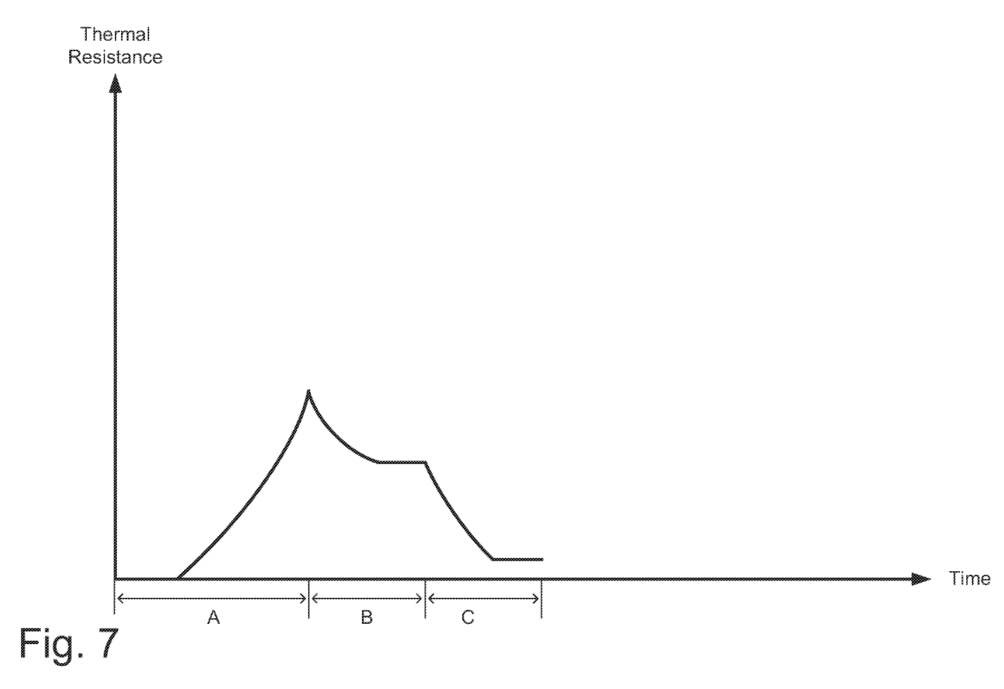

Turning to FIG. 7, an example of deposition monitoring apparatus 100 operating in accordance with the method of FIG. 4 is depicted. In this example, the first treatment configuration of deposition monitoring apparatus 100 removes biofilm deposition and the second treatment configuration of deposition monitoring apparatus 100 removed inorganic scaling deposition. Further, once deposition monitoring apparatus 100 enters the first or second treatment configurations, deposition monitoring apparatus 100 remains in the treatment configuration until the rate of deposition removal from the conductive deposition monitoring surface 102 is less than a predetermined rate.

At the beginning of time period A, the conductive deposition monitoring surface 102 is exposed to the water, a baseline measurement of deposition DM₀ is obtained, and the current time is recorded as T₀, and deposition is collected on conductive deposition monitoring surface 102. Deposition continues forming on conductive deposition monitoring surface 102 throughout time period A, which ends once a predetermined event occurs. At the beginning of time period B a first measurement of deposition DM₁ is taken using deposition measurement system 104, the current time is recorded as T₁, and deposition monitoring apparatus 100 is placed in a first treatment configuration. Deposition monitoring apparatus 100 remains in the first treatment configuration until the rate of deposition removal from the conductive deposition monitoring surface 102 is less than a predetermined rate, which occurs at the end of time period B. As can be seen, during time period B the first treatment configuration removed the biofilm portion of the deposition present on the conductive deposition monitoring surface 102. After exiting the first treatment configuration, a second measurement of deposition DM₂ is obtained and the time is recorded as T₂.

At the beginning of time period C, deposition monitoring apparatus 100 is placed in a second treatment configuration. Deposition monitoring apparatus 100 remains in the second treatment configuration until the rate of deposition removal from the conductive deposition monitoring surface 102 is less than a predetermined rate, which occurs at the end of time period C. As can be seen, during time period C, the second treatment configuration removes the inorganic scale portion of the deposition present on the conductive deposition monitoring surface 102. However, a small portion of other deposition still remains on conductive deposition monitoring surface 102 at the end of time period C. After exiting the second treatment configuration, a third measurement of deposition DM₃ is obtained and the time is recorded as T₃. This third measurement of deposition DM₃ accounts for the other deposition remaining on conductive deposition monitoring surface 102 at the end of time period C. The deposition statistics are then calculated and DM₀ is set equal to DM₃ to account for the other deposition remaining on conductive deposition monitoring surface 102.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention. Therefore, the technical scope of the present invention encompasses not only those embodiments described above, but also all that fall within the scope of the appended claims.

This written description uses examples to disclose the invention, including the best mode, and also to enable any person skilled in the art to practice the invention, including making and using any devices or systems and performing any incorporated processes. The patentable scope of the invention is defined by the claims, and may include other examples that occur to those skilled in the art. These other examples are intended to be within the scope of the claims if they have structural elements that do not differ from the literal language of the claims, or if they include equivalent structural elements with insubstantial differences from the literal language of the claims.

What is claimed is:

1. A method of deposition monitoring in a water system comprising:
inserting a deposition measurement system, a conductive deposition monitoring surface and a counter electrode into the water system, said conductive deposition monitoring surface and said counter electrode are connected to a DC power supply;
exposing said conductive deposition monitoring surface to said water, obtaining a baseline measurement of deposition DM₀, and recording the current time as T₀;
collecting deposition on said conductive deposition monitoring surface for a predetermined length of time;
obtaining a first measurement of deposition DM₁ on said conductive deposition monitoring surface and recording the current time as T₁;
initiating a current through said conductive deposition monitoring surface and said counter electrode with said DC power supply in a first treatment configuration, and terminating said current after a predetermined length of time;
obtaining a second measurement of deposition DM₂ on said conductive deposition monitoring surface and recording the current time as T₂;
initiating a current through said conductive deposition monitoring surface and said counter electrode with said DC power supply in a second treatment configuration, and terminating said current after a predetermined length of time; and
obtaining a third measurement of deposition DM₃ on said conductive deposition monitoring surface and recording the current time as T₃.

2. The method of claim 1,
wherein said first treatment configuration is comprised of:
connecting said conductive deposition monitoring surface to receive a negative polarity voltage from said DC power supply and connecting said counter electrode to receive a positive polarity voltage from said DC power supply;
wherein said first treatment configuration removes biofilm deposition from said conductive deposition monitoring surface; and
wherein said second treatment configuration is comprised of:
connecting said conductive deposition monitoring surface to receive a positive polarity voltage from said DC power supply and connecting said counter electrode to receive a negative polarity voltage from said DC power supply;
wherein said second treatment configuration removes inorganic scale deposition from said conductive deposition monitoring surface.

3. The method of claim 2, further comprising:
calculating a rate of biofilm deposition using:
(DM₁−DM₂)/(T₁−T₀);
calculating a rate of inorganic scale deposition using:
(DM₂−DM₃)/(T₂−T₀);and
calculating a rate of other depositions using:
(DM₃−DM₀)/(T₃−T₀);
wherein the thickness of biofilm removed by said first treatment configuration is equivalent to:
DM₁−DM₂;
wherein the thickness of inorganic scale removed by said second treatment configuration is equivalent to:
DM₂−DM₃;and
wherein the thickness of other deposition present on said conductive deposition monitoring surface is equivalent to:
DM₃.

4. The method of claim 1,
wherein said first treatment configuration is comprised of:
connecting said conductive deposition monitoring surface to receive a positive polarity voltage from said DC power supply and connecting said counter electrode to receive a negative polarity voltage from said DC power supply;
wherein said first treatment configuration removes inorganic scale deposition from said conductive deposition monitoring surface; and
wherein said second treatment configuration is comprised of:
connecting said conductive deposition monitoring surface to receive a negative polarity voltage from said DC power supply and connecting said counter electrode to receive a positive polarity voltage from said DC power supply;
wherein said second treatment configuration removes biofilm deposition from said conductive deposition monitoring surface.

5. The method of claim 4, further comprising:
calculating a rate of inorganic scale deposition using:
(DM₁−DM₂)/(T₁−T₀);
calculating a rate of biofilm deposition using:
(DM₂−DM₃)/(T₂−T₀);
calculating a rate of other depositions using:
(DM₃−DM₀)/(T₃−T₀);
wherein the thickness of inorganic scale removed by said first treatment configuration equivalent to:
DM₁−DM₂;
wherein the thickness of biofilm removed by said second treatment configuration is equivalent to:
DM₂−DM₃;and
wherein the thickness of other deposition present on said conductive deposition monitoring surface is equivalent to:
DM₃.

6. The method of claim 1, wherein said deposition thicknesses are obtained through a deposition measurement system that uses one or more of the electrical, optical, or thermal properties of said conductive deposition monitoring surface to measure deposition on said conductive deposition monitoring surface.

7. The method of claim 1, wherein said current in said first treatment configuration is terminated after flowing between about 5 seconds to about 300 seconds, and said current in second treatment configuration is terminated after flowing between about 5 seconds to about 300 seconds.

8. The method of claim 1, wherein deposition is collected on said conductive deposition monitoring surface for a predetermined length of time between about one hour and about one year.

9. The method of claim 8, wherein deposition is collected on said conductive deposition monitoring surface for a predetermined length of time between about one month and about three months.

10. The method of claim 9, wherein deposition is collected on said conductive deposition monitoring surface for a predetermined length of time between about one week and about one month.

11. An apparatus for deposition monitoring in a water system comprising:
a deposition measurement system;
a DC power supply connected to a conductive deposition monitoring surface and a counter electrode;
said apparatus having a first treatment configuration and a second treatment configuration; and
wherein one of said treatment configurations removes biofilm from said conductive deposition monitoring surface, and the other of said treatment configurations removes inorganic scale deposition from said conductive deposition monitoring surface.

12. The apparatus of claim 11, wherein said conductive deposition monitoring surface is connected to receive positive polarity voltage from said DC power supply and said counter electrode is connected to receive negative polarity voltage from said DC power supply in said first treatment configuration; and said conductive deposition monitoring surface is connected to receive negative polarity voltage from said DC power supply and said counter electrode is connected to receive positive polarity voltage from said DC power supply in said second treatment configuration.

13. The apparatus of claim 12, wherein said apparatus calculates a rate of biofilm deposition, cumulative biofilm deposition, a rate of inorganic scale deposition, and cumulative inorganic scale deposition.

14. The apparatus of claim 11, wherein said conductive deposition monitoring surface is connected to receive negative polarity voltage from said DC power supply and said counter electrode is connected to receive positive polarity voltage from said DC power supply in said first treatment configuration; and said conductive deposition monitoring surface is connected to receive positive polarity voltage from said DC power supply and said counter electrode is connected to receive negative polarity voltage from said DC power supply in said second treatment configuration.

15. The apparatus of claim 14, wherein said apparatus calculates a rate of biofilm deposition, cumulative biofilm deposition, a rate of inorganic scale deposition, and cumulative inorganic scale deposition.

16. A method of deposition monitoring in a water system comprising:
inserting a deposition measurement system, a conductive deposition monitoring surface and a counter electrode into the water system, said conductive deposition monitoring surface and said counter electrode are connected to a DC power supply;
exposing said conductive deposition monitoring surface to said water and recording the current time as T₀;
obtaining a first measurement of deposition DM₁ on said conductive deposition monitoring surface and recording the current time as T₁;
repeating said first measurement of deposition DM₁ on said conductive deposition monitoring surface and recording the current time as T₁ until said first measurement of deposition DM₁ exceeds a predetermined thickness;
initiating a current through said conductive deposition monitoring surface and said counter electrode with said DC power supply in a first treatment configuration, monitoring the rate of deposition removal from said conductive deposition monitoring surface, and terminating said current when the rate of deposition removal from said conductive deposition monitoring surface is less than a predetermined rate of deposition removal;
obtaining a second measurement of deposition DM₂ on said conductive deposition monitoring surface and recording the current time as T₂;
initiating a current through said conductive deposition monitoring surface and said counter electrode with said DC power supply in a second treatment configuration, monitoring the rate of deposition removal from said conductive deposition monitoring surface, and terminating said current when the rate of deposition removal from said conductive deposition monitoring surface is less than a predetermined rate of deposition removal; and
obtaining a third measurement of deposition DM₃ on said conductive deposition monitoring surface and recording the current time as T₃; and
calculating at least one deposition statistic.

17. The method of claim 16,
wherein biofilm deposition is removed from said conductive deposition monitoring surface in said first treatment configuration by:
connecting said conductive deposition monitoring surface to receive negative polarity voltage from said DC power supply and connecting said counter electrode to receive positive polarity voltage from said DC power supply;
wherein inorganic scale deposition is removed from said conductive deposition monitoring surface in said second treatment configuration by:
connecting said conductive deposition monitoring surface to receive positive polarity voltage from said DC power supply and connecting said counter electrode to receive negative polarity voltage from said DC power supply; and
wherein said predetermined rate of deposition removal is between about 2 μm/second to about 0.25 μm/second.

18. The method of claim 16,
wherein inorganic scale deposition is removed from said conductive deposition monitoring surface in said first treatment configuration by:
connecting said conductive deposition monitoring surface to receive positive polarity voltage from said DC power supply and connecting said counter electrode to receive negative polarity voltage from said DC power supply;
wherein biofilm deposition is removed from said conductive deposition monitoring surface in said second treatment configuration by:
connecting said conductive deposition monitoring surface to receive negative polarity voltage from said DC power supply and connecting said counter electrode to receive positive polarity voltage from said DC power supply; and
wherein said predetermined rate of deposition removal is between about 2 μm/second to about 0.25 μm/second.

19. The method of claim 17, wherein said deposition statistics are comprised of the rate of biofilm deposition, rate of inorganic deposition, and rate of other depositions.

20. A method of deposition monitoring in a water system comprising:
inserting a deposition measurement system, a conductive deposition monitoring surface and a counter electrode into the water system, said conductive deposition monitoring surface and said counter electrode are connected to a DC power supply;
exposing said conductive deposition monitoring surface to said water, obtaining a baseline measurement of deposition DM₀ and recording the current time as T₀;
collecting deposition on said conductive deposition monitoring;
obtaining a first measurement of deposition DM₁ on said conductive deposition monitoring surface and recording the current time as T₁;
initiating a current through said conductive deposition monitoring surface and said counter electrode with said DC power supply in a first treatment configuration, and terminating said current after a predetermined length of time;
obtaining a second measurement of deposition DM₂ on said conductive deposition monitoring surface and recording the current time as T₂;
initiating a current through said conductive deposition monitoring surface and said counter electrode with said DC power supply in a second treatment configuration, and terminating said current after a predetermined length of time;
obtaining a third measurement of deposition DM₃ on said conductive deposition monitoring surface and recording the current time as T₃; and
calculating at least one deposition statistic.

21. The method of claim 20, wherein deposition is collected on said conductive deposition monitoring surface until a predetermined length of time elapses, or an abnormal operation of the water system occurs that increases deposition risks.

22. The method of claim 20, wherein the currents in said first and second treatment configurations are terminated after a predetermined length of time elapses or the rate of deposition removal from said conductive deposition monitoring surface is less than a predetermined rate of deposition removal.
